(19) United States
(12) Patent Application Publication
(10) Pub. No.: US 2025/0029114 A1
(43) Pub. Date: Jan. 23, 2025

(54) ARTIFICIAL INTELLIGENCE SMART ANSWERING ARCHITECTURE

(71) Applicant: SoundHound AI IP, LLC, Santa Clara, CA (US)

(72) Inventors: Timothy P. Stonehocker, Sunnyvale, CA (US); Kamyar Mohajer, Princeville, HI (US)

(73) Assignee: SoundHound AI IP, LLC, Santa Clara, CA (US)

(21) Appl. No.: 18/356,659

(22) Filed: Jul. 21, 2023

(51) Int. Cl. G06Q 30/016; G06N 5/046

(52) U.S. Cl. CPC G06Q 30/016; G06N 5/046

(57) ABSTRACT

An automated answering system and method are disclosed for use in providing automated customer service. The automated answering system uses generative artificial intelligence to aid in forming a knowledgebase of information regarding a merchant's business that is used in answering the customer queries. The automated answering system of the present technology also uses generative artificial intelligence to aid in formulating a response to queries using the formed knowledgebase.

### FIELD

The present technology relates to a smart answering system for automated customer service using generative artificial intelligence in the development of a knowledgebase for answering customer queries, and in the use of the knowledgebase during live customer interaction to answer customer queries.

### BACKGROUND

Traditional customer service systems using human operators have to an extent given way to automated customer service solutions such as interactive voice response systems (IVR) and online chatbots. While occasionally an improvement over human operators, conventional automated customer service systems have significant drawbacks. For example, such systems have rigid constraints around the format and structure of the data that is captured, stored and used to answer customer queries. In addition to significant set up times, these rigid data constraints make it difficult for such automated customer service systems to handle a wide range of customer queries. The result is often a frustrating customer experience, having to waste time with an ineffective automated assistant before being transferred to a human operator. Automated service systems have been frustrating for merchants as well, given the poor customer experience and the need to maintain a full compliment of human operators.

Artificial intelligence (AI) has some potential to advance automated customer service systems. However, one significant drawback to the use of AI in customer service systems is the tendency of AI systems to fabricate information. This so-called AI-induced hallucination can result in the automated assistant providing false responses to customer queries, a result which is as bad if not worse than not providing an answer at all.

### DESCRIPTION OF THE DRAWINGS

FIG. 1 is a schematic representation of a smart answering system according to embodiments of the present technology.

FIG. 2 is a flowchart for forming a knowledgebase for use in the smart answering system according to embodiments of the present technology.

FIG. 3 is a flowchart showing further detail of the operation of step 204 of FIG. 2 according to embodiments of the present technology.

FIG. 4 is an illustration of a graphical user interface presented by a smart answering system to a merchant according to embodiments of the present technology.

FIG. 5 is a further illustration of a graphical user interface presented by a smart answering system to a merchant according to embodiments of the present technology.

FIG. 6 is a further illustration of a graphical user interface presented by a smart answering system to a merchant according to embodiments of the present technology.

FIG. 7 is a further illustration of a graphical user interface presented by a smart answering system to a merchant according to embodiments of the present technology.

FIG. 8 is a further illustration of a graphical user interface presented by a smart answering system to a merchant according to embodiments of the present technology.

FIG. 9 is a flowchart of the operation of the smart answering system of the present technology in a live interaction with a customer to answer customer queries.

FIG. 10 is a schematic block diagram of a computing environment according to embodiments of the present technology.

### DETAILED DESCRIPTION

The present technology will now be described with reference to the figures, which in general relate to a smart answering system for use in providing automated customer service for example over a telephone. The automated answering system of the present technology uses generative artificial intelligence to aid in forming a knowledgebase of information regarding a merchant's business that is used in answering customer queries. The automated answering system of the present technology also uses generative artificial intelligence to aid in formulating a response to queries using the formed knowledgebase.

The knowledge base of the smart answering system includes labels which are facts, information or items of truth relating to a merchant's business. The various labels may relate to any aspects of the merchant's business, including for example location, hours of operation, services provided, etc. In embodiments, the labels are generated by scraping the merchant's website, and then inputting text from the website into a generative artificial intelligence (GAI) engine. The GAI engine identifies facts and other information about the merchant's business from the input text, and generates the labels from these facts and other information. Using a knowledge of the type of business in which the merchant is engaged, the GAI engine may additionally suggest labels which it did not find from the website text. The labels may then be presented on a graphical user interface to the merchant, who can edit and/or add additional labels to the knowledgebase.

Once the merchant is satisfied the knowledgebase is has reached a sufficient level of completeness, the merchant may then use the knowledgebase to answer customer and other user queries. Upon receipt of a query, for example over a telephone, the query may be converted to text. The present technology then forms a prompt for input into the GAI engine. The prompt may include the query, the entire knowledgebase, and boundary instructions directing the GAI engine to limit its response to the information found in the knowledgebase. This prevents the GAI engine from hallucinating and ensures that it returns a factually correct result based on the labels and information in the knowledgebase.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

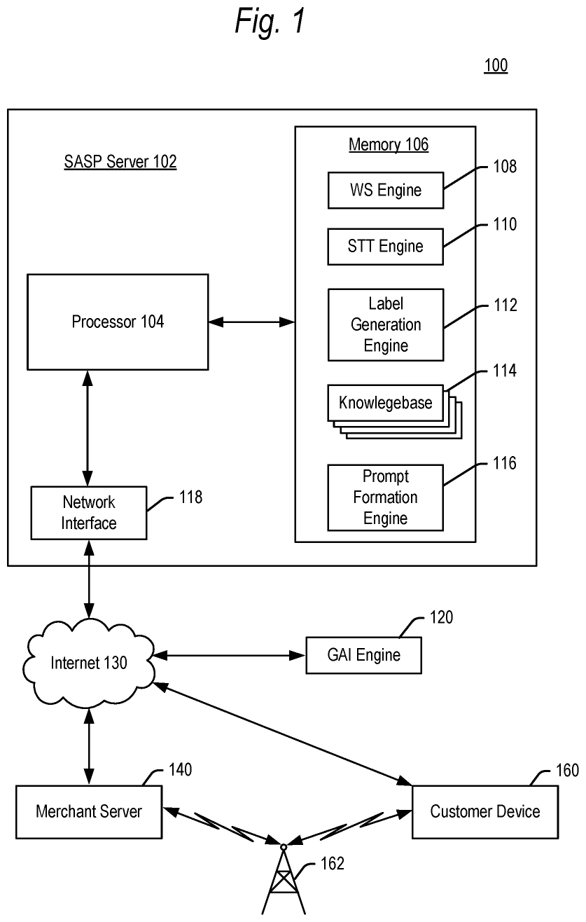

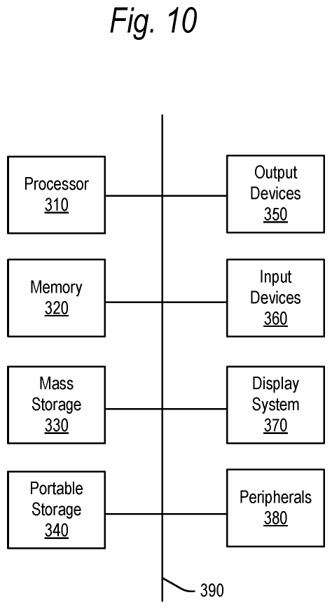

FIG. 1 is a schematic block diagram of a sample smart answering architecture 100 for implementing the present technology. Architecture 100 may include a server owned or controlled by a smart answering service provider, referred to herein as SASP server 102. In further embodiments, server 102 may be comprised of multiple servers, collocated or otherwise. A more detailed explanation of a sample server 102 is described below with reference to FIG. 10, but in general, server 102 may include a processor 104 configured to control the operations of server 102, as well as facilitate communications between various components within server 102. The processor 104 may include a standardized processor, a specialized processor, a microprocessor, or the like that may execute instructions for controlling server 102. As explained below, processor 104 may include, or be in communication with, a generative artificial intelligence engine 120 for implementing aspects of the present technology.

The server 102 may further include a memory 106 that may store algorithms that may be executed by the processor 104. According to an example embodiment, the memory 106 may include RAM, ROM, cache, Flash memory, a hard disk, and/or any other suitable storage component. As shown in FIG. 1, in one embodiment, the memory 106 may be a separate component in communication with the processor 104, but the memory 106 may be integrated into the processor 104 in further embodiments.

Memory 106 may store various software application programs executed by the processor 104 for controlling the operation of the server 102. Such application programs may for example include a website scraping (WS) engine 108 and a speech-to-text (STT) engine 110. The WS engine 108 is configured to send an HTML request to a target website. Upon receiving the HTTP response, the engine retrieves the text content of the various pages of the website and stores the website text in a file in memory 106. The STT engine 110 receives audio, for example from a customer calling into a merchant as explained below, and converts the audio into text. The converted text is then stored in a file in memory 106.

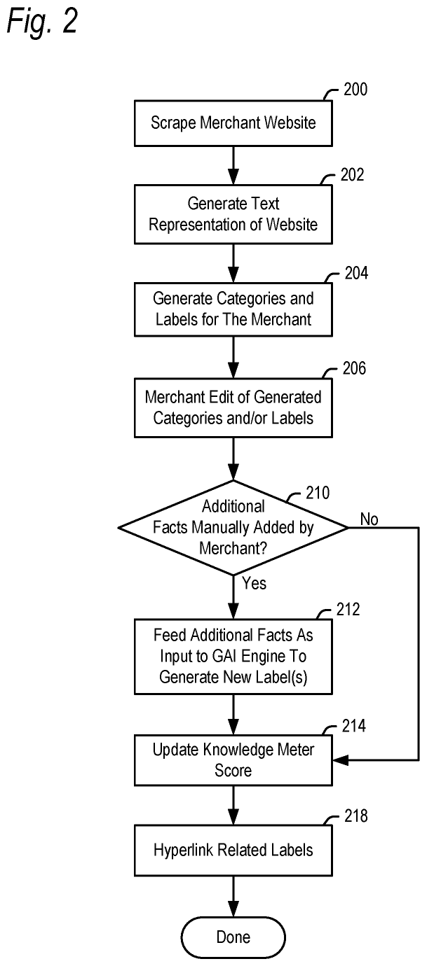

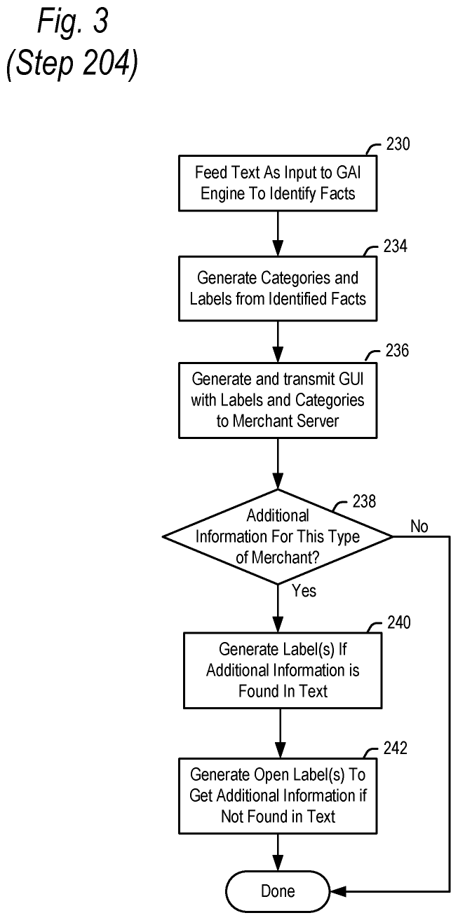

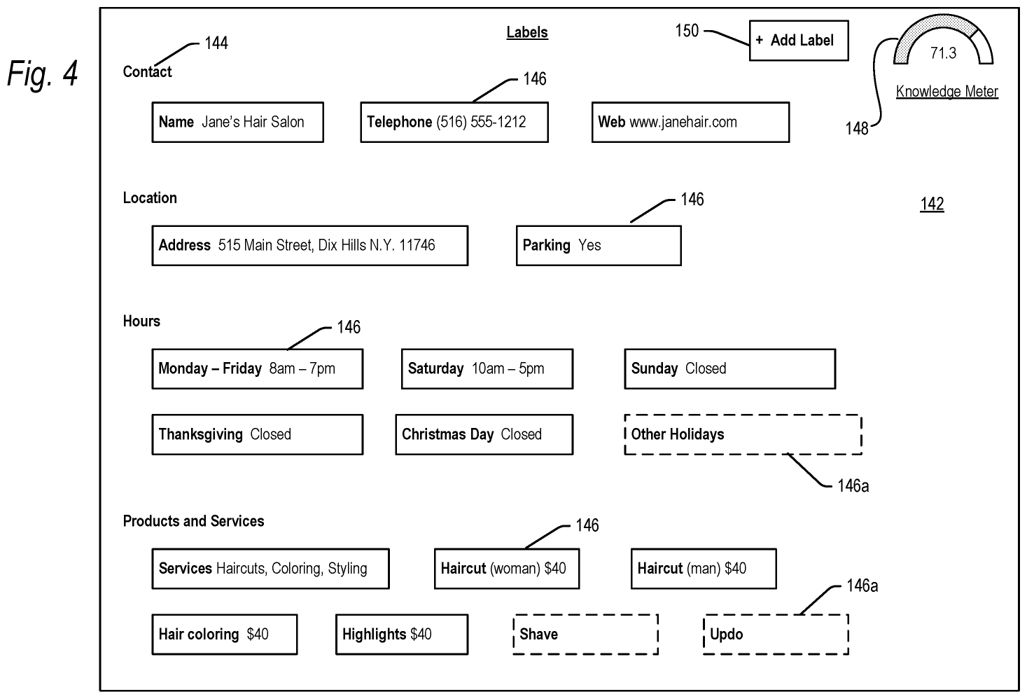

Memory 106 may further include label generation engine 112 and a knowledgebase 114, which is a data store including all ascertained information regarding one or more merchant businesses. As explained below, the label generation engine 112 in tandem with GAI engine 120 and, possibly, manual curation by the merchant, generates facts and other information regarding a merchant's business, which facts and other information are stored in memory 106 in data records referred to herein as labels. The corpus of all labels generated for a given merchant comprises the knowledgebase 114. The operation of label generation engine 112 to create a knowledgebase 114 for each merchant is explained in greater detail below with respect to the flowcharts of FIGS. 2-3 and the illustrations of FIGS. 4-8. The knowledgebase 114 for each merchant may be stored in separate datafiles in memory 106.

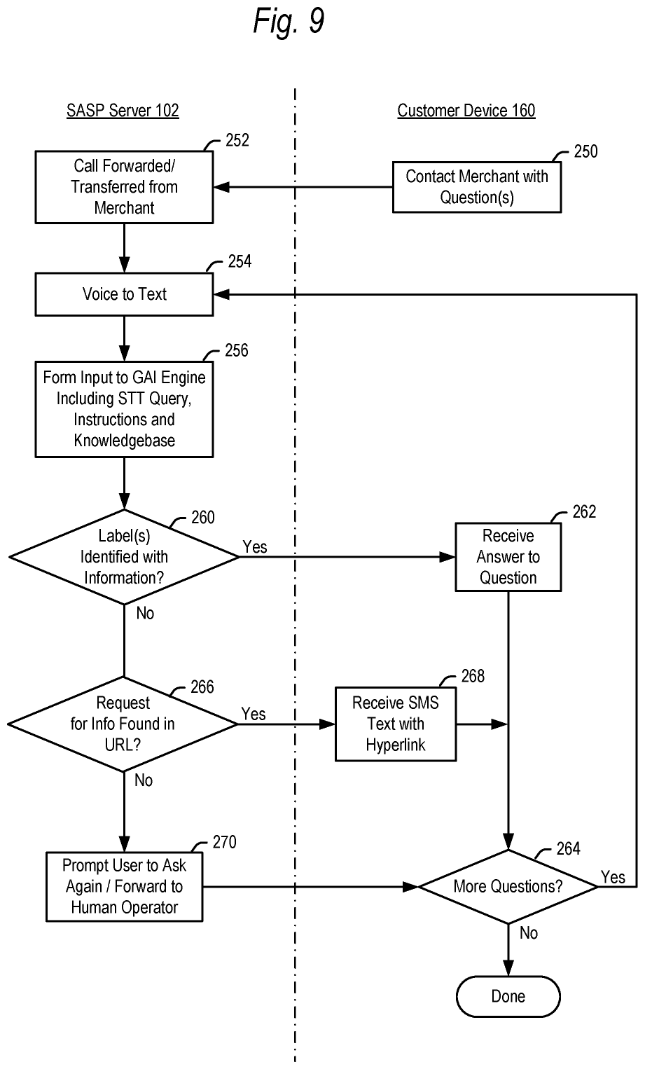

As explained hereinafter, the SASP server 102 supports a merchant through a smart answering system that answers customer call-in queries regarding the merchant's business. Upon receipt of a customer or other user query, the query is transferred to SASP server 102, which converts the audio query to a text file by the STT engine 110. The SASP server 102 further includes a prompt formation engine 116 which formulates a prompt using the textual query, a knowledgebase 114 and a set of boundary instructions, which prompt is then sent to the generative artificial intelligence engine 120 to generate a response to the prompt. The operation of the prompt formation engine 116 and its interaction with the generative artificial intelligence engine 120 is explained in greater detail below with reference to FIG. 9. In further embodiments, memory 106 may store application programs in addition to the WS engine 108, the STT engine 110, label generation engine 112 and the prompt formation engine 116.

The server 102 may further include communications circuitry such as a network interface 118 for connecting to the Internet 130. The server 102 may include additional components for example as described below with respect to FIG. 10.

As mentioned, embodiments of the present technology use generative artificial intelligence (GAI) to both build a knowledgebase 114 and to implement the knowledgebase 114 to handle user queries during a live interaction with a telephone caller. In embodiments, the processor 104 may be in communication with a GAI engine 120 via the Internet 130. In further embodiments, the GAI engine 120 may be integrated into the processor 104 of SASP server 102. GAI engine 120 receives an input, or prompt, and uses models and algorithms to generate an output including new, original content based on a given dataset on which engine 120 is trained. GAI engine 120 may be an existing generative neural network, such as ChatGPT-3, ChatGPT-4, or other known models. These models have been trained on extensive datasets and possess the ability to generate coherent and contextually relevant text based on provided input.

Alternatively, GAI engine 120 may be a generative neural network customized specifically for use with the present technology. In general, training and developing the GAI engine 120 in this instance may involve the following steps.

Data Collection and Preprocessing: The GAI engine 120 may be provided with a large dataset of examples representing the desired type of content to be generated. In one embodiment, these datasets comprise facts and items of truth that may be picked out of text included on a merchant website. There may be different datasets for different types of merchants or merchant websites. The data may be preprocessed to ensure consistency, remove noise, and normalize the input format.

Model Architecture Selection: The GAI engine 120 may be configured in different model architectures, including for example a generative adversarial network (GAN), a variational autoencoder (VAE), an autoregressive model, or other types of models designed for generative tasks.

Training the Model: The GAI engine 120 may then be trained using the prepared dataset. During training, the model learns the underlying patterns, structures, and statistical properties of the input data. The specifics of training depend on the chosen model architecture.

Generator Component: The GAI engine 120 may include a generator component responsible for generating new content based on random or controlled input. The generator component may utilize techniques such as neural networks, deep learning, or probabilistic models to produce new and original output that resembles the patterns and characteristics of the training data.

Discriminator or Evaluation Component: Where GAI engine 120 is configured as a GANs, an additional component called a discriminator may be incorporated. The discriminator evaluates the generated content and provides feedback to improve the generator's output quality. This adversarial training process helps refine the generator's ability to create more realistic output.

Iterative Improvement: The training process iterates multiple times, with the generator component generating new content and the GAI engine 120 adjusting its internal parameters based on feedback from the discriminator and/or evaluation component. This iterative process allows the GAI engine 120 to improve its output quality over time.

Sampling and Output Generation: Once the GAI engine 120 is trained, it can generate new content by sampling from the learned distribution of the training data. By providing input to the generator component, either random noise or controlled parameters, the GAI engine 120 can produce novel content that shares similarities with the original training data.

It is understood that the above steps for developing and training GAI engine 120 are by way of example only and other or alternative steps may be used to develop and/or train a GAI engine 120 customized for use with the present technology.

FIG. 2 is a flowchart showing the operation of the smart answering architecture 100 in tandem with GAI engine 120 to build the knowledgebase 114. Once a merchant has on-boarded with the smart answering service provider, the website scraping engine 108 of SASP server 102 may scrape the merchant's website in step 200, and generate and store a text representation of all pages in the merchant's website in step 202.

In step 204, the label generation engine 112 feeds the text file of the merchant's website to GAI engine 122 to generate the categories and labels of the knowledgebase 114 for the merchant. Further details of step 204 will now be explained with reference to the flowchart of FIG. 3.

In step 230, the stored text representation of the merchant's website is fed into the GAI engine 120, a page at a time or all at once. Where GAI engine 120 is remote from SASP server 102, the step involves the transmission of the text data file to GAI engine 120 over the Internet 130. As described above, the GAI engine 120 is trained to identify facts and other pertinent merchant information from the received text data file. These facts and other merchant pertinent information can relate to any aspect of the merchant's website that customers and others might inquire about when contacting the merchant. The GAI engine may also be trained to classify the identified facts and merchant information into different categories. The GAI engine can respond to requests for categorization based on the information in the knowledgebase 114, and instructions around how to categorize (e.g., the GAI engine is asked to categorize the data based the types of questions customers typically ask a business of this sort). As set forth below, categories may be predefined in further embodiments.

In embodiments, the GAI engine 120 identifies facts and other information from the text representation of the merchant's website. It is understood that in further embodiments, the GAI engine 120 may receive text files or other information relating to a merchant's business from any of a wide variety of other sources. These other sources may for example include text from brochures, advertisements, product specifications and other written media. These other sources may for example include audio from radio advertisements or the like that are captured by the SASP 102 and converted to text by the STT engine 110. These other sources may for example include video from television advertisements or Internet video clips, from which the audio is captured by the SASP 102 and converted to text by the STT engine 110. Text from these and possibly other sources may be captured and fed to the GAI engine 120 from which the GAI engine can then identify facts and other pertinent information regarding the merchant used to build the knowledgebase 114.

Thus, scraping a merchant's website is one of many ways the knowledgebase 114 may be populated. As a further example, the knowledgebase 114 may be augmented by entering free-form text. For example, “this Saturday our special is 20% off all hair products,” may be transformed automatically into a label “Saturday Special: 20% off hair products.” In addition, the GAI engine 120 may populate the knowledgebase automatically with other information, that might be relevant to a business based on its prior knowledge and/or available on the World Wide Web.

The facts and other pertinent information, organized by category, may be received in the label generation engine 112 from the GAI engine 120. In step 234, the label generation engine 112 may organize and save this information by labels within the one or more categories. This information may be transmitted for display in a graphical user interface to merchant server 140 in step 236. FIG. 4 is an illustration of a graphical user interface 142 showing one example of how the generated categories 144 and labels 146 may be displayed to the merchant. In the example shown, the merchant is a hair salon, and the categories 144 and labels 146 (some of which are numbered) relate to such things as the name, telephone and website of the business, location of the business, hours of operation and products and services. The particular categories and labels shown are illustrative and a wide variety of other categories and labels may be identified in further embodiments.

It is a feature of the present technology that each of the categories and labels generated and shown to the merchant in the graphical user interface 142 of FIG. 4 was generated by the GAI engine 120 without manual curation by the merchant or others. The present technology automatically generates the knowledgebase 114 at least in part because the GAI engine 120 can take data in an unstructured format (e.g., simple text), and organize it into labels 146. This is an improvement over conventional systems where the databases used to provide automated customer service were manually created with rigid constraints on how the data was entered. As explained below, the labels and/or categories need not be generated by GAI engine 120 in further embodiments.

The GAI engine 120 is able to take data in an unstructured format (e.g., simple text), and organize it into labels by a variety of different methods. In one example, The GAI engine 120 can be trained to summarize a paragraph, for example, from the merchant's website or elsewhere, and organize it into labels based on a predefined format. As one of a large variety of examples, the GAI engine 120 may be trained to summarize freeform text it receives regarding the merchant, such as, “we offer mens' haircuts, and the price starts at $20, and we offer womens' haircuts, and minimum for that is $40” into a first label “Mens' Haircut: $20+,” and another label “Womens' haircut: $40+”. The process of converting freeform text into labels can be repeated as many times as needed to provide full coverage for the input information that is provided to the GAI engine 120 and provide a full summary of, for example, the merchant's website. As explained below, a merchant is given the option to manually curate how information from its website is turned into labels. Modification by a merchant of a label generated by the GAI engine 120 may be fed back to the GAI engine so that it can be further trained on how to take freeform text and turn it into labels.

In addition to identifying facts and information from a merchant's website, the GAI engine 120 may generate other labels, not expressly found on a particular merchant's website, but which the GAI engine 120 identifies as being of potential interest to customers of this type of merchant. In particular, the GAI engine 120 can discern the business of the merchant from the received text file, and has been trained that certain facts are pertinent to customers of this type of business, whether or not found from this particular merchant's input information.

In step 238, the GAI engine 120 can check for this additional information. If found, the GAI engine can go back over the received website text file to see if facts corresponding to this additional information are found. If so, the information is returned to the label generation engine 112 in step 240 for generation as a label 146. The GAI engine 120 may additionally or alternatively simply return the additional information to the label generation engine 112 in step 242, which in turn creates a label referred to herein as an open label 146a, shown in dashed lines in FIG. 4. Open labels include generic information identified by GAI engine 120, but which need to be customized for a particular merchant. For example, although not found in this merchant's website, the GAI engine 120 identified that customers of a hair salon may want information regarding services for a shave or an updo. As such, open labels 146a for these generic services were automatically added to the knowledgebase 114 by GAI engine 120 and shown on the graphical user interface 142. Thus, even where a merchant's website is basic, the present technology may generate a robust knowledgebase 114 with many labels 146 and/or open labels 146a. It is understood that the term “label” as used herein broadly refers to any and all information that is or may be gathered and used to describe aspects of a merchant's business or the merchant in general.

While the knowledgebase 114 and labels 146 may be generated by the GAI engine, the merchant is able to review the labels generated by the GAI engine and make any changes to customize the knowledgebase 114 and labels 146 to the merchant's satisfaction. For example, the merchant is given the opportunity to remove open labels 146a, or any other label 146, automatically generated by the GAI engine 120. In one embodiment, a merchant may select a label 146 by clicking on it or hovering over it on the graphical user interface 142, and be given a menu option to delete the label. In the same way, the merchant may be given the option to rename a label generated by the GAI engine. Labels 146 may be deleted or edited on interface 142 by other methods in further embodiments. Moreover, as explained below, the merchant may also be given an option to add additional labels.

The graphical user interface 142 shown to the merchant may include a knowledge meter 148. In embodiments, the knowledge meter 148 may present a numerical value (e.g., a percentage) of how complete the knowledgebase 114 is. The value shown in the knowledge meter 140 may be calculated as a ratio of the number of labels 146 over the sum of the number of labels 146 and the number of open labels 146a. It is understood that the value shown in the knowledge meter may be calculated by other ways in further embodiments.

In embodiments described above and hereinafter, label generation to build the knowledgebase 114 is performed by the GAI engine 120. However, in further embodiments, the knowledgebase may be built without the use of the GAI engine and without the use of artificial intelligence. In such embodiments, the knowledgebase 114 may still be built automatically by an algorithm in the SASP server which scrapes the merchant's website and/or the World Wide Web to gather the information used to build the knowledgebase 114. Alternatively or additionally, the knowledgebase 114 may be built manually by the merchant and/or service provider controlling SASP server 102.

Regarding categories, in some embodiments, these may be automatically generated by the GAI engine 120 or service provider. In further embodiments, a predefined list of categories may be used, and populated with labels as determined by any embodiment described herein. The predefined list may for example include, hours and location, policies, products and services, transfers, customer self-serve, and other Information. These predefined categories are by way of example only, and there may be other predefined categories instead of or in addition to these listed predefined categories.

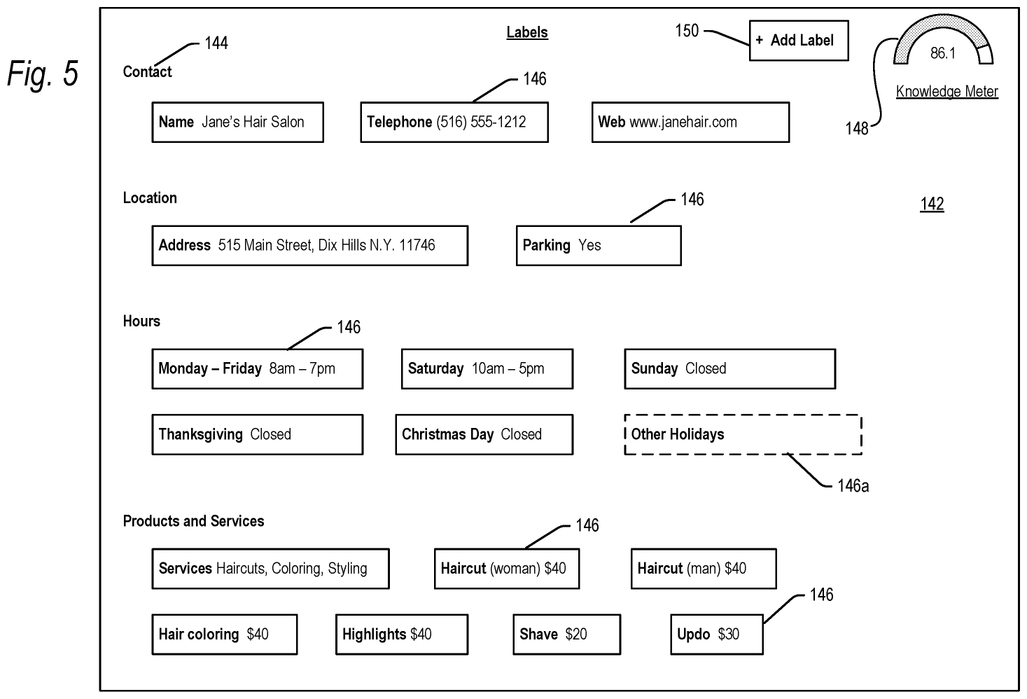

Returning to the flowchart of FIG. 2, in step 206, the merchant is given the option to manually curate the knowledgebase 114. For example, as shown in the graphical user interface 142 of FIG. 5, the merchant has addressed some of the open labels (the cost of a shave and updo at the bottom of FIG. 5) by adding prices for these services, thereby converting these to regular labels 146. The value of the knowledge meter 148 increases accordingly.

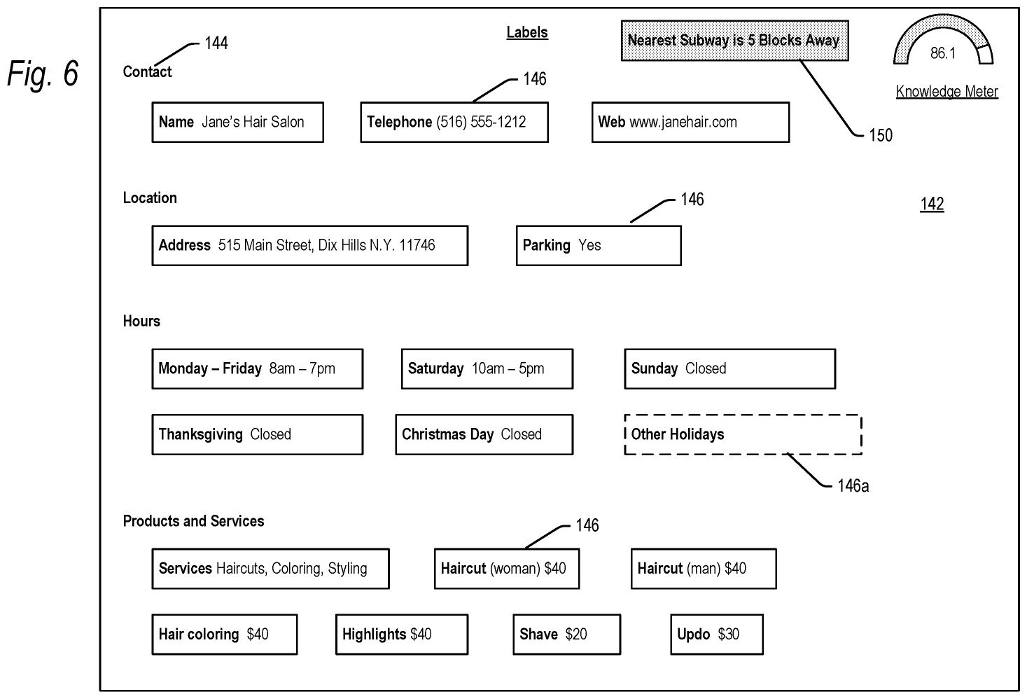

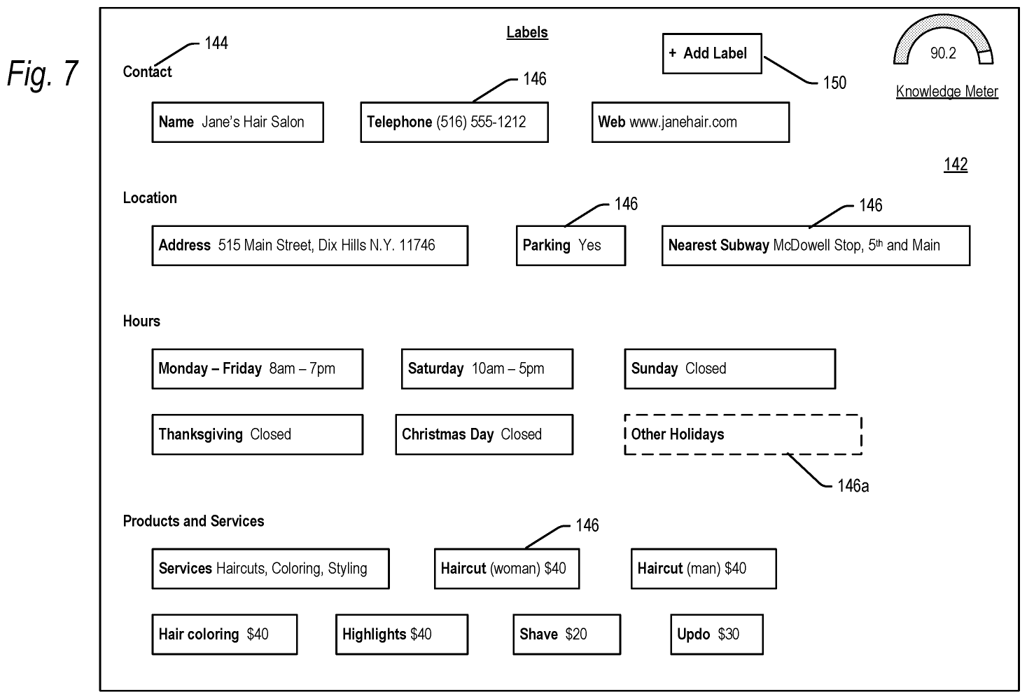

In step 210, the merchant is also given the option to manually add one or more additional labels 146 to the knowledgebase 114. The graphical user interface 142 may include a button 150 enabling the user to manually add such labels. For example, as shown in the graphical user interface 142 of FIG. 6, the merchant has chosen to add a label relating to the nearest subway station to the merchant's place of business. The user interface 142 may be updated to include the manually-added label 146 as shown in FIG. 7. It is noteworthy that the label generation engine 112 may take the newly added label and feed it to the GAI engine 120 (step 212), which may return a category 144 for the new label, and may also change the description of the new label to something with more concise and/or pertinent information. For example, in FIG. 7, the GAI engine 120 and/or the label generation engine 112 identified the name of the subway station closest to the merchant's place of business and its address, and added this as the label for the nearest subway. At least in this way, the GAI engine 120 generates the labels 146 in knowledgebase 114 so that they are optimized for use in answering queries during a live interaction customer service session.

In another embodiment, the merchant (or GAI engine) can add URLs to one or more labels. For example, “Appointments: Encouraged” may be a label (automatically or manually generated). A URL may be manually added by the merchant, or automatically added by the GAI engine, attached to this label for making appointments.

In step 214, the knowledge meter 148 may be generated or updated to reflect any manual curation by the merchant.

It may happen that the GAI engine 120 and/or the merchant indicates that two or more labels 146 are related to each other, for example as category and subcategory. In step 218, the label generation engine 112 may hyperlink any such related labels, which hyperlink and relation may be useful when using the knowledgebase 114 to fulfill customer queries as explained hereinafter.

As explained in the Background section, it is a drawback to conventional automated answering systems that they have rigid constraints around the format and structure of the data that is captured, stored and used to answer customer queries. The labels are generally formatted in a way that would enable the GAI engine 120 to answer prompts without requiring a specific format of the prompts. The GAI engine is generally able to interpret input without rigid formatting requirements. Thus, information provided to the GAI engine in a prompt may be unformatted, or formatted in a variety of simple or different ways, and the GAI engine is able to interpret the prompt. This makes it easier and faster to generate, store and use the labels 146 to answer customer queries.

Moreover, the automated and/or simple manual creation of labels allows for a wide variety of sophisticated labels to be created, as well as conditions for labels. For example, one or more of the labels may include an expiration date. The interface 142 may provide an option associated with each displayed label to set a date on which that label is removed or changed. Thus, for example, where merchant is running a special on a provided service or product through a certain date, a label may be created to accurately reflect what and for how long the merchant is offering the service or product.

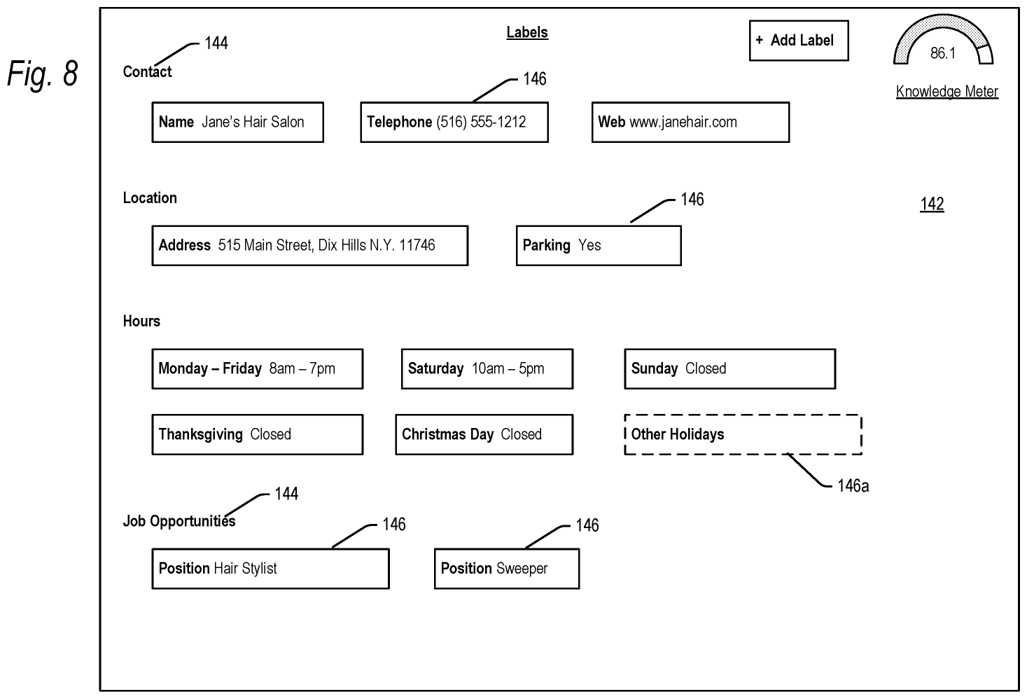

Typically, it will be customers that contact a merchant with queries, and the labels may therefore center around information such customers may be interested in. However, it is understood that the labels may relate to any facts or information pertinent to a merchant and its business. For example, in FIG. 8, there is a category 144 and labels 146 included for job opportunities available at the merchant. These labels will be useful to job applicants who are connected to the smart answering system of the present technology when contacting a merchant.

In general, it is a feature of the present technology that labels may be automatically generated by GAI engine 120, or easily added by the merchant, to enable the smart answering system of the present technology to provide helpful information in response to any query the merchant may receive. Should it happen that a user requests information that the smart answering system of the present technology is unable to provide, this instance may be referred back to the GAI engine 120 and/or the SASP 102 so that a label 146 may be created for this feature. Thus, such a query will be properly answered by the smart answering system in the future.

The above embodiments describe a smart answering system for easily generating a robust knowledgebase 114 through the use of GAI engine 120. In a further aspect of the present technology, the knowledgebase 114 and the GAI engine 120 may also be used by the smart answering system to provide automated and effective response to customer queries during a live interaction session with a caller. Such a live interaction session will now be described with reference to the schematic drawing of FIG. 1 and the flowchart of FIG. 9.

In step 250, the merchant server 140 may receive a telephone call from a customer device 160, either via the Internet 130 or via a mobile communications network 162. This call is forwarded or transferred to the SASP server 102 in step 252. The call at that time may take place directly between the customer device and the SASP server. Alternatively, the merchant server 140 may remain on the call as an intermediary. In step 254, the STT engine 110 of the SASP server 102 may convert the call audio of the customer query to text.

In step 256, the prompt formation engine 116 of the SASP server 102 forms an input, or prompt, to the GAI engine 120. In accordance with aspects of the present technology, this prompt includes the textual query, the entire knowledgebase 114 and a set of boundary instructions. This set of boundary instructions instructs GAI engine 120 to provide an answer to the included text query as if the GAI engine 120 was a customer representative tasked with answering such queries.

Also in accordance with aspects of the present technology, the set of boundary instructions further instructs the GAI engine 120 to limit its answer to the information included within the knowledgebase 114; i.e., to find the answer to the query from the set of labels 146. As noted in the Background section it is a feature of generative artificial intelligence modules to hallucinate and fabricate answers to questions that may not be correct. This problem is solved by the present technology by providing a finite corpus of information (the knowledgebase), and limiting the GAI engine to finding the answer, if at all, within that corpus of information.

As noted, in embodiments, the entire knowledgebase 114 is sent with the query. However, in further embodiments, a partial knowledgebase (i.e., some portion of the whole knowledgebase) is sent. It may happen that the entire knowledgebase may not be relevant to a given query. In this embodiment, preprocessing of the query is performed (either by algorithm at the SASP server 102 or by the GAI engine 120) to determine which part or parts of the knowledgebase is/are relevant, and that portion is then sent with the prompt. This may be useful if the knowledgebase gets large, for example to reduce token size of the prompt that gets sent to the GAI engine with each query.

It is a drawback to conventional automated answering systems that the queries need to be in specific formats. While the producers of such systems try to handle the multitude of different formats in which a given query may be asked, it is very difficult to cover all such query formats for a large number of different queries. This problem is solved by the present technology. Queries that are fed to the GAI engine 120 do not need to be in specific formats. The GAI engine is flexible in that a given query can be asked in any format, and it will still be understood and handled by the GAI engine 120.

Upon receiving the prompt, the GAI engine generates a response within the confines of the boundary instructions, and returns a response to the SASP server 102. In step 260, the server 102 determines whether one or more labels 146 were identified as being responsive to the user's question. If so, the information is provided to the user in step 262. As noted, the GAI engine is directed to respond as if it were a customer service representative handling a customer call. As one simple example, a caller may connect to the smart answering system of the present technology and asks:

“Is your store open at all on weekends?”

The GAI engine would search the knowledge base 114 and for example respond: “Yes, we are open 10 am to 5 pm on Saturdays. We are closed on Sundays.”

If the user has further questions in step 264, the user's further question is converted to text in step 254 as explained above and the process at the SASP and GAI servers repeats. If the user has no further questions in step 264, the call ends and the process is complete.

It may happen that the user query can only be fulfilled by access to the merchant website or some third-party website. As one of a wide variety of examples, a customer may access the smart answering system of the present technology when contacting a restaurant and request to make a reservation over the phone. In this instance, the GAI server 120 itself cannot fulfill the request, but may return a uniform resource locator (URL) that can fulfill the request (the reservations page for the restaurant in this example). In step 266, the SASP server 102 may check if the answer to a query includes a URL from the GAI server 120. If so, the server 102 may generate an SMS text to the customer in step 268 including a hyperlink to the requested URL.

Should it happen that the GAI engine was unable to identify a label in step 260, the user may be prompted to ask the question again, or ask a different question in step 270. Alternatively, if no label is identified after one or more attempts, the caller may be transferred to a human operator. In embodiments, the user interface 142 shown for example in FIG. 4, may include an option for the merchant to set a resistance level. Such a resistance level may be used to determine how quickly unsuccessfully answered queries are transferred to human operator. For example, a low resistance setting may mean that calls are transferred to human operator after one or relatively few unsuccessfully answered questions. A high resistance setting may mean calls are not transferred to a human operator until several attempts to get a correct answer through the smart answering architecture 100.

FIG. 10 illustrates an exemplary computing system 300 that may be server 102 or server used to implement an embodiment of the present technology. The computing system 300 of FIG. 10 includes one or more processors 310 and main memory 320. Main memory 320 stores, in part, instructions and data for execution by processor unit 310. Main memory 320 can store the executable code when the computing system 300 is in operation. The computing system 300 of FIG. 10 may further include a mass storage device 330, portable storage medium drive(s) 340, output devices 350, user input devices 360, a display system 370, and other peripheral devices 380.

The components shown in FIG. 10 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a floppy disk, compact disk or Digital video disc, to input and output data and code to and from the computing system 300 of FIG. 10. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 10 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 10 are those typically found in computing systems that may be suitable for use with embodiments of the present invention and are intended to represent a broad category of such computer components that are well known in the art. Thus, the computing system 300 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for automated answering of customer queries, comprising: one or more service provider servers configured to receive the customer queries; and a generative artificial intelligence (GAI) engine trained on answering customer queries; wherein the one or more service provider servers and the GAI engine together generate at least one of: i) a knowledgebase including information used to answer the customer queries, and ii) an answer to a customer query using the knowledgebase.

In another example, the present technology relates to a system for automated answering of customer queries, comprising: one or more service provider servers configured to receive a customer query of the customer queries, and configured to generate a prompt for analysis by a generative artificial intelligence (GAI) engine trained on answering customer queries; wherein the prompt comprises: the customer query; a knowledgebase of information regarding a merchant to which the customer query is directed; and a set of boundary instructions instructing the GAI engine to limit its answer to the customer query to the information within the knowledgebase.

In a further example, the present technology relates to a method of automated answering of customer queries, comprising: generating a knowledgebase of information relating to a merchant business to which a customer query of the customer queries is directed, the step of generating the knowledgebase being assisted at least in part by a generative artificial intelligence (GAI) engine; and answering automatedly a customer query using the knowledgebase, the step of answering automatedly the customer query being assisted at least in part by the GAI engine.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A system for automated answering of customer queries, comprising:
one or more service provider servers configured to receive the customer queries; and
a generative artificial intelligence (GAI) engine trained on answering customer queries;
wherein the one or more service provider servers and the GAI engine participate in the generation of a knowledgebase including information used to answer the customer queries.

2. The system of claim 1 wherein the one or more service provider servers and the GAI engine further participate in the generation of an answer to a customer query using the knowledgebase.

3. The system of claim 1 wherein the GAI engine automatically generates the knowledgebase without need of manual curation.

4. The system of claim 1 wherein the GAI engine automatically generates the knowledgebase upon receiving a text file including information regarding a merchant's business to which the customer query is directed.

5. The system of claim 4, wherein the information regarding the merchant's business is scraped from the merchant's website.

6. The system of claim 4, wherein the text file is generated by the one or more service provider servers.

7. The system of claim 1, wherein the GAI engine is further trained to identify facts from a received data file containing text from a website of a merchant to which the customer query is directed.

8. The system of claim 1, wherein upon receipt of information relating to a merchant business to which the customer query is directed, the GAI engine uses the information to generate labels containing facts about the merchant business, the labels used to form the knowledgebase.

9. The system of claim 1, wherein the one or more service provider servers scrape a website of a merchant to which the customer query is directed to generate a textual representation of the website, and transmits the textual representation of the website to the GAI engine for analysis.

10. The system of claim 9, wherein upon receipt of the textual representation of the website, the GAI engine uses the textual representation of the website to generate labels containing facts about the merchant business, the corpus of labels forming the knowledgebase.

11. The system of claim 10, wherein upon receipt of the textual representation of the website, the GAI engine suggests labels related to the business of the merchant that are not found in the textual representation of the website.

12. The system of claim 10, wherein two or more labels determined by the GAI engine to be related to each other are hyperlinked to each other.

13. The system of claim 10, wherein upon receipt of the labels the one or more service provider servers are configured to allow manual curation of the labels.

14. The system of claim 13, wherein the manual curation includes at least one of the addition of new labels, the amendment of labels generated by the GAI engine and deletion of labels generated by the GAI engine.

15. A system for automated answering of customer queries for a merchant, comprising:
one or more service provider servers configured to receive the customer queries; and
a generative artificial intelligence (GAI) engine trained on answering customer queries;
wherein the one or more service provider servers and the GAI engine participate in the generation of an answer to a customer query using a knowledgebase of information relating to the merchant.

16. The system of claim 15, wherein the GAI engine is constrained in its answer by the set of boundary instructions to prevent hallucination by the GAI engine.

17. The system of claim 15, wherein the GAI engine returns a uniform resource locator (URL) in response to the query, the one or more service provider servers forwarding a link to the URL to the customer.

18. The system of claim 15, wherein the GAI engine assists in generating the knowledgebase prior to receipt of the query.

19. The system of claim 15, further comprising a speech-to-text (STT) engine on the one or more service provider servers, the STT engine converting the audio of the received query to text for inclusion in the prompt.

20. A system for automated answering of customer queries, comprising:
one or more service provider servers configured to receive a customer query of the customer queries, and configured to generate a prompt for analysis by a generative artificial intelligence (GAI) engine trained on answering customer queries;
wherein the prompt comprises:
the customer query;
a knowledgebase of information regarding a merchant to which the customer query is directed; and
a set of boundary instructions instructing the GAI engine to limit its answer to the customer query to the information within the knowledgebase.

21. The system of claim 20, further comprising a GAI engine configured to form an answer to the customer query as an automated customer service representative.

22. The system of claim 20, further comprising a GAI engine configured to form an answer to the customer query, wherein the GAI engine is constrained in its answer by the set of boundary instructions to prevent hallucination by the GAI engine.

23. The system of claim 20, further comprising a GAI engine configured to form an answer to the customer query, wherein the GAI engine returns a uniform resource locator (URL) in response to the query, the one or more service provider servers forwarding a link to the URL to the customer.

24. The system of claim 20, wherein the GAI engine assists in generating the knowledgebase prior to receipt of the query.

25. A method of automated answering of customer queries, comprising:
generating a knowledgebase of information relating to a merchant business to which a customer query of the customer queries is directed, the step of generating the knowledgebase being assisted at least in part by a generative artificial intelligence (GAI) engine; and
answering automatedly a customer query using the knowledgebase, the step of answering automatedly the customer query being assisted at least in part by the GAI engine.

26. The method of claim 25, the step of generating the knowledgebase comprising the step of scraping a website of the merchant to generate a textual representation of the website.

27. The method of claim 26, the step of generating the knowledgebase further comprising receipt at the GAI engine of the textual representation of the website, and generating by the GAI engine labels containing facts about the merchant business.

28. The method of claim 27, the step of generating the knowledgebase further comprising generating by the GAI engine labels related to the business of the merchant that are not found in the textual representation of the website.

29. The method of claim 25, wherein the step of generation of the knowledgebase further comprises manual curation of the facts about the merchant in the knowledgebase.

30. The method of claim 25, wherein the step of answering automatedly the customer query using the knowledgebase comprises forming a prompt including the customer query, the knowledgebase and a set of boundary instructions, and sending the prompt to the GAI engine.

31. The method of claim 30, wherein the GAI engine generates a response to the prompt in the form of a customer assistance reply to the query.

32. The method of claim 30, wherein the GAI engine generates a response to the prompt under the constraints imposed by the set of boundary instructions to limit the response to facts contained within the knowledgebase.

33. The method of claim 25, wherein the step of generating the knowledgebase of information relating to the merchant business is further assisted in part by one or more servers of an automated answering service provider.

34. The method of claim 33, wherein the step of answering automatedly the customer query is further assisted in part by the one or more servers of the automated answering service provider.
